(19) United States
(12) Patent Application Publication
(10) Pub. No.: US 2009/0268241 A1
(43) Pub. Date: Oct. 29, 2009

(54) METHOD OF CONTROLLING A PRINT JOB AND A TERMINAL DEVICE USING THE SAME

(75) Inventors: Mi-kyung Choi, Suwon-si (KR); Sang-hyup Lee, Suwon-si (KR); Young-joo Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/428,752

(22) Filed: Apr. 23, 2009

(30) Foreign Application Priority Data
Apr. 25, 2008 (KR) 2008-38858

(51) Int. Cl. G06F 3/12

(52) U.S. Cl. 358/1.15

(57) ABSTRACT

A method of controlling a print job using a universal print driver of a terminal device connectable to a plurality of image forming apparatuses. The method can include selecting one of the plurality of image forming apparatuses, selecting pre-stored printing options of the plurality of image forming apparatuses, determining whether the pre-stored printing options are available on the image forming apparatus for which the universal print driver is selected, and displaying that the pre-stored printing option is unavailable, if at least one of the pre-stored printing options is unavailable. Therefore, a user can easily recognize information regarding unavailable pre-stored printing options.

### CROSS-REFERENCE TO RELATED APPLICATIONS

This application claims priority under 35 U.S.C. §119(a) from Korean Patent Application No. 2008-38858, filed on Apr. 25, 2008, in the Korean Intellectual Property Office, the contents of which are incorporated herein by reference in its entirety.

### BACKGROUND

1. Field of the Inventive Concept

The present general inventive concept relates to a method of controlling a print job and a terminal device using the same, and more particularly to a print control method to display information regarding whether a pre-stored printing option is available for a currently used image forming apparatus in a printing environment using a universal print driver, and provides a user with alternative printing options, and a terminal device using the same.

2. Description of the Related Art

Generally, when a user desires a document written using an application program to be printed using an image forming apparatus such as a printer or a multifunctional periphery (MFP), a printing control device such as a computer requires a print driver in order to control print jobs of an image forming apparatus.

The print driver provides a user interface (UI) to set printing options for a document to be printed. A user may set printing options to be applied to a document to be printed, such as the paper size, paper type, and paper tray, duplex printing, stapler, offset, overlay, water mark, or N-up, using a UI.

A user may set printing options by combining a plurality of printing options, and may predetermine or pre-store a frequently used printing option as a favorite printing option.

Recently, a plurality of image forming apparatuses have been able to be connected to a user terminal by a local area network, and a universal print driver may control a printing job of the plurality of image forming apparatuses.

FIG. 1 is a schematic view provided to explain a printing method of a conventional image forming apparatus. Referring to FIG. 1, a plurality of image forming apparatuses 20a to 20d are connected to a user terminal device 10. The image forming apparatus 20a is connected to the user terminal device 10 locally, and the image forming apparatuses 20b to 20d are connected to the user terminal 20 via a network. A user may control a printing job of the plurality of image forming apparatuses 20a to 20d using a universal print driver.

As the image forming apparatuses 20a to 20d support different functions, the printing options applied to one image forming apparatus may not be applied to the other image forming apparatuses. If printing options are set for the plurality of image forming apparatuses using a universal print driver, printing options applied to one image forming apparatus are not applied to other image forming apparatuses. For example, a duplex printing option may be set in an image forming apparatus 20a which supports duplex printing, but cannot be set in an image forming apparatus 20d which does not support duplex printing.

A conventional universal print driver does not provide information regarding whether the pre-stored printing option can be applied to the image forming apparatus selected by a user, which causes a user to experience inconvenience when setting the printing option.

Even if a user can recognize that it is impossible for the pre-stored printing options to be applied to the image forming apparatus, the information regarding alternatives to the unavailable printing option are not provided to the user. Therefore, in order to set a printing option, the user must check all of the printing options.

### SUMMARY

The present general inventive concept provides a method of controlling a print job to display information regarding whether a pre-stored printing option is available for a currently used image forming apparatus in a printing environment using a universal print driver, and provides a user with alternative printing options, and a terminal device thereof.

Additional embodiments of the present general inventive concept will be set forth in part in the description which follows and, in part, will be obvious from the description, or may be learned by practice of the general inventive concept.

Example embodiments of the present general inventive concept may be achieved by providing a method of controlling a printing job using a universal print driver of a terminal device connectable to a plurality of image forming apparatuses, the method including selecting one of the plurality of image forming apparatuses, selecting pre-stored printing options for the plurality of image forming apparatuses, determining whether the pre-stored printing options are available on the image forming apparatus for which the universal print driver is selected, and displaying that the pre-stored printing option is unavailable, if at least one of the pre-stored printing options is unavailable.

The displaying may include displaying an icon indicating that the printing option is unavailable adjacent to the pre-stored printing option, if the pre-stored printing option is unavailable.

The displaying may include displaying a message as a tool tip indicating that the printing option is unavailable, if the pre-stored printing option is unavailable.

The method may further include searching for other printing options as alternatives to the pre-stored printing options.

The method may further include asking a user whether to adjust the pre-stored printing options.

The method may further include displaying the printing options which are searched, if alternative printing options to the printing option are searched, and displaying that there are no alternatives to the printing option, if alternatives to the printing option are not searched.

The method may further include selecting at least one of the alternative printing options, and setting the selected printing option for the selected image forming apparatus, if alternative printing options to the printing option are searched.

The setting may include displaying printing conditions to be applied in advance, if a user selects at least one of the alternative printing options.

The setting may further include storing the set printing option.

The storing may include storing the set printing option as an alternative to the selected pre-stored printing options.

Example embodiments of the present general inventive concept may also be achieved by providing a terminal device to control a print job using a universal print driver connectable to a plurality of image forming apparatuses, the device including a user interface (UI) to receive a printing option setting, a storage unit to store pre-stored printing options for the plurality of image forming apparatuses, a determination unit to determine whether the pre-stored printing options are available on the image forming apparatus selected for the universal print driver, and a control unit to control the UI in order to display that the pre-stored printing options are unavailable if the pre-stored printing options are unavailable.

The UI may generate a user interface (UI) window comprising a first area on which pre-stored printing options are displayed and a second area on which the availability of pre-stored printing options is displayed.

If the pre-stored printing options are unavailable, the UI may display an icon on the second area of the UI window indicating that the pre-stored printing options are unavailable.

The UI may display a message as a tool tip indicating that the printing options are unavailable.

The device may further include a searching unit to search for other printing options as alternatives to the pre-stored printing options.

The UI may ask a user whether to adjust the pre-stored printing options.

If alternative printing options are searched, the UI may display the printing options which are searched, and if alternative printing options are not searched, the UI may display that there are no alternative printing options.

If a user selects at least one of the alternative printing options, the UI may display printing conditions to be applied in advance.

If alternative printing options are searched, the control unit may set at least one of the alternative printing options input through the UI of the image forming apparatus.

The control unit may store the set printing options in the storage unit as pre-stored printing options for the plurality of image forming apparatuses.

Example embodiments of the present general inventive concept may also be achieved by providing a terminal device to control a print operation of a plurality of image forming apparatuses, including a user interface (UI) to set a printing option of a selected image forming apparatus, a print driver to determine whether the set printing option is available to the selected image forming apparatus, and a control unit to control the UI to display a result of the determining.

The terminal device may further include a storage device to store printing options of the plurality of image forming apparatuses, wherein when the print driver determines that the set printing option is not available to the selected image forming apparatus, the print driver searches the storage device to determine whether alternative printing options are available to the selected image forming apparatus.

When it is determined that at least one alternative printing option is available to the selected image forming apparatus, the user interface can display a preview area to display printing results corresponding to the at least one alternative printing option before the print operation is carried out by the selected image forming apparatus.

The determining of whether alternative printing options are available to the selected image forming apparatus can be performed according to a user's selection from the user interface or a predetermined algorithm.

At least one alternative printing option can be stored as a favorite printing option of the selected image forming apparatus when it is determined that alternative printing options are available to the selected image forming apparatus.

Example embodiments of the present general inventive concept may also be achieved by providing a method of setting a printing option of a plurality of image forming apparatuses, the method including setting a printing option of a selected image forming apparatus, determining whether the set printing option is available to the selected image forming apparatus, and displaying a result of the determining.

The method may further include storing predetermined printing options of the plurality of image forming apparatuses, and searching the predetermined printing options to determine whether alternative printing options are available to the selected image forming apparatus when it is determined that the set printing option is not available to the selected image forming apparatus.

When it is determined that at least one alternative printing option is available to the selected image forming apparatus, a preview area can be displayed to display printing results corresponding to the at least one alternative printing option before a print operation of the selected image forming apparatus is performed.

The method may further include storing at least one alternative printing option as a favorite printing option of the selected image forming apparatus when it is determined that alternative printing options are available to the selected image forming apparatus.

The method may further include selecting an alternative image forming apparatus when it is determined that the set printing option is not available to the selected image forming apparatus.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a schematic view provided to explain a printing method of a conventional image forming apparatus;

FIG. 2 is a block diagram illustrating a terminal according to an exemplary embodiment of the present general inventive concept;

FIGS. 3 to 6 are perspective views illustrating various exemplary embodiments of a user interface (UI) window of a terminal device according to an exemplary embodiment of the present general inventive concept; and

FIG. 7 is a flowchart provided to explain a print control method according to an exemplary embodiment of the present general inventive concept.

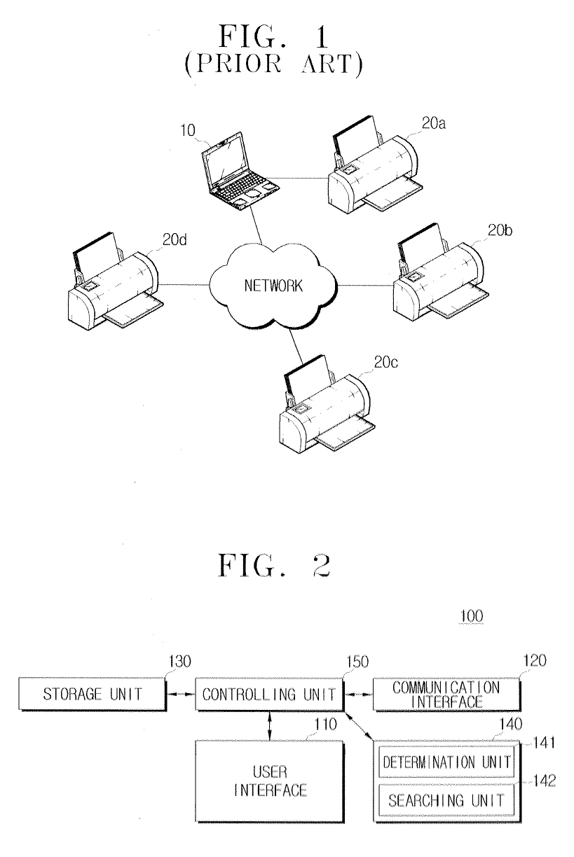

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

FIG. 2 is a block diagram illustrating a terminal device according to an exemplary embodiment of the present general inventive concept. Referring to FIG. 2, a terminal device 100 to control a print job may include a user interface 110, a communication interface 120, a storage unit 130, a universal print driver 140, and a controlling unit 150.

The user interface 110 can include a plurality of function keys which enable a user to set or select various functions supported by the terminal device 100, and can display various information provided from the terminal device 100. The user interface 110 may be embodied as a device such as a touch pad to simultaneously achieve an input and output, and may be embodied as a device combining a mouse and a monitor. A user may select an image forming apparatus to print a document, and may set printing options to be applied to the selected image forming apparatus using a user interface (UI) window provided on the user interface 110.

More specifically, the user interface 110 may provide a UI window in which a user may select an image forming apparatus from among a plurality of image forming apparatuses to print a document, and a UI window in which a user may select printing options to apply the corresponding image forming apparatus and the printing options pre-stored in the plurality of image forming apparatuses. The printing options of the plurality of image forming apparatuses may form a single printing option or may be implemented as a combination of the plurality of printing options.

The user interface 110 may generate a UI window including a first area on which pre-stored printing options can be displayed and a second area on which the availability of pre-stored printing options can be displayed. The user interface 110 may display a message indicating an unavailable printing option as a tool tip, and/or searched printing options. An exemplary UI window to display the availability of printing options will be explained below.

The communication interface 120 can be connected to an image forming apparatus, and can provide the image forming apparatus with printing data. The communication interface 120 can be provided to connect the terminal device 100 to an external apparatus, and can be, for example, a parallel port, a universal serial bus (USB) port, or a wireless module.

The storage unit 130 can store information regarding the pre-stored printing options. Specifically, the pre-stored printing options may be frequently used printing options, for example a duplex printing option, or printing options preset by a user, for example a printing option combining duplex printing and 2 up printing. The storage unit 130 may store a plurality of printing options, or classifiably store printing options pre-stored for each user.

If a user desires to print a document written using an application program, the universal print driver 140 can convert the document to printable data. The universal print driver 140 can provide printing conditions of the plurality of image forming apparatuses connected thereto, and can determine whether the pre-stored printing options are available on the selected image forming apparatus. If one of the printing options selected from among the pre-stored printing options is unavailable, the universal print driver 140 may search for other printing options as alternatives to the selected printing option. As illustrated in FIG. 2, the universal print driver 140 may include a determination unit 141 and a searching unit 142.

The determination unit 141 can determine whether the pre-stored printing options are available on the image forming apparatus selected for the universal print driver 140. More specifically, the determination unit 141 may receive information regarding printing options which may be set for the image forming apparatus connected thereto through the communication interface 120, and can determine whether the pre-stored printing options are available for the image forming apparatus which a user selects on the universal print driver 140 using the information. For example, if a user sets A4 size and duplex printing on an image forming apparatus, the determination unit 141 may determine that the printing options are unavailable since another image forming apparatus does not support duplex printing as a printing option.

If the pre-stored printing options are unavailable, the searching unit 142 can search for other printing options as alternatives to the unavailable printing options. The alternative printing options can be used to output the same printed matter even if additional operations are required. For example, if an alternative to the duplex printing option is used, it is still possible that odd pages may be printed on printing media, and even pages may also be printed on the printing media. As a result, the same printed matter as that of duplex printing can be output using an alternative printing option. The searching unit 142 may use an auto search algorithm. The auto search algorithm can be used to search for printing options to enable the same printed matter as that of the pre-stored printing option to be acquired. The database initially input by a developer may be used while executing the auto search algorithm. The database may be updated according to the alternative printing options set by the user. One or more alternative printing options may be provided.

If there are no alternative printing options to replace the pre-stored printing options, the searching unit 142 may output the initial printing option of the image forming apparatus as the alternative printing option. For example, if a color printing option is preset, an image forming apparatus supporting only mono printing cannot provide any printing options as alternatives to the color printing option. Accordingly, the image forming apparatus can provide the initial options thereof as alternative options.

If the determination unit 141 of the universal print driver 140 determines that the pre-stored printing options selected by a user are unavailable, the control unit 150 may control the user interface 110 to display a message stating that the pre-stored printing options are unavailable. If a user selects an unavailable printing option from among the pre-stored printing options, the control unit 150 can cause the user interface 110 to display that the corresponding image forming apparatus does not support the selected printing option.

Referring to FIG. 2, the control unit 150 can control the searching unit 142 of the universal print driver 140 to search for printing options to use as alternatives to the pre-stored printing options selected by a user. Specifically, the control unit 150 may ask a user whether to search for alternative printing options through the user interface 110, and if the user desires to search for alternative printing options, the control unit 150 can control the searching unit 142 to search alternative printing options. Alternative printing options may also be automatically searched for without asking a user whether to search for alternative printing options.

The control unit 150 may cause the printing options searched by the searching unit 142 of the universal print driver 140 to be displayed through the user interface 110. Specifically, the control unit 150 can cause the user interface 110 to display printing options searched by the searching unit 142, and thus a user can check whether to apply the searched printing option to the image forming apparatus. If a plurality of printing options are searched for, the control unit 150 can display the plurality of printing options on the user interface 110, and thus a user may select one of the searched printing options as a printing option of the image forming apparatus through the user interface 110. If one printing option is searched for, a user may decide whether to apply the printing option to the image forming apparatus using the user interface 110.

The control unit 150 may set other printing options in addition to, or instead of, the alternative printing option according to the user's selection. For example, if a plurality of printing options are searched, the control unit 150 may set the printing options searched by the searching unit 142 as the printing option of the corresponding image forming apparatus according to a predetermined priority order.

If a user selects one of the alternative printing options, the control unit 150 may control the user interface 110 to preliminarily display a printing condition corresponding to the selected printing option. If it is possible for a user to select a plurality of printing options, the form of printing medium on which printing will be performed may be displayed on an area of a UI window in order to display the form of the medium to be printed in advance.

The control unit 150 may store in the storage unit 130 printing options searched by the searching unit 142 of the universal print driver 140 and alternative printing options selected by a user. Since the searched printing options may be set as favorite printing options, the control unit 150 may store the searched printing options in the storage unit 130. The control unit 150 may add the searched printing options to pre-stored printing options, or replace the searched printing options with the currently selected pre-stored printing options to store the printing options. The operation of storing the searched printing options may be performed by a user command, or may be automatically performed without receiving a user command. It is also possible that the control unit 140 can control the universal print driver 140 and/or the user interface 140 to select an alternative image forming apparatus which supports the selected or alternative printing option.

A user can obtain information regarding unavailable printing options for the currently selected image forming apparatus, and may easily set alternative printing options.

According to the above exemplary embodiments of the present general inventive concept, the terminal device 100 to control a print job may include a personal computer, and/or an image forming apparatus such as a copy machine, an inkjet printer, a laser beam printer (LBP), or a multi functional peripheral (MFP).

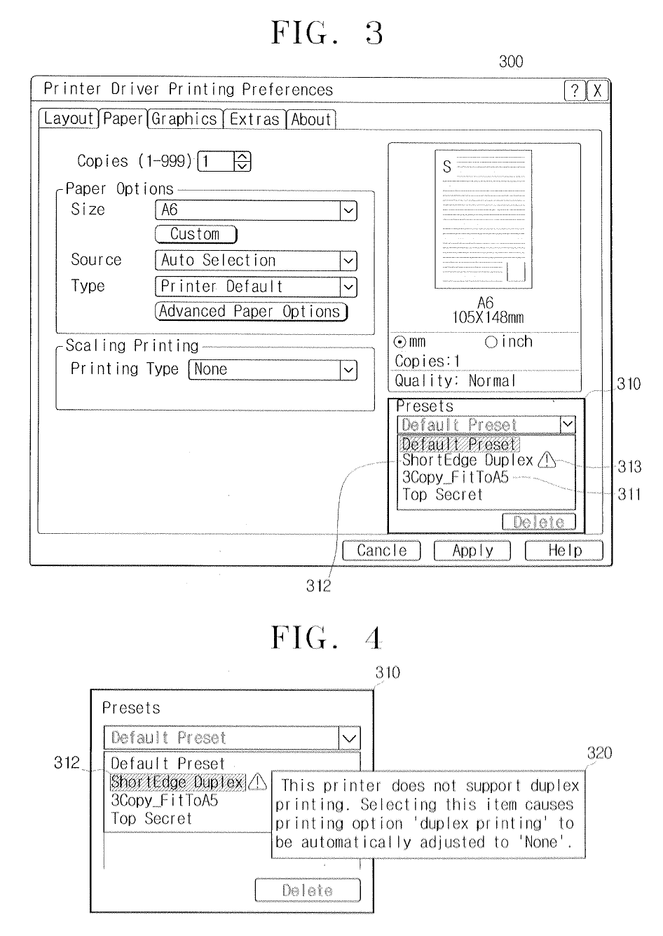

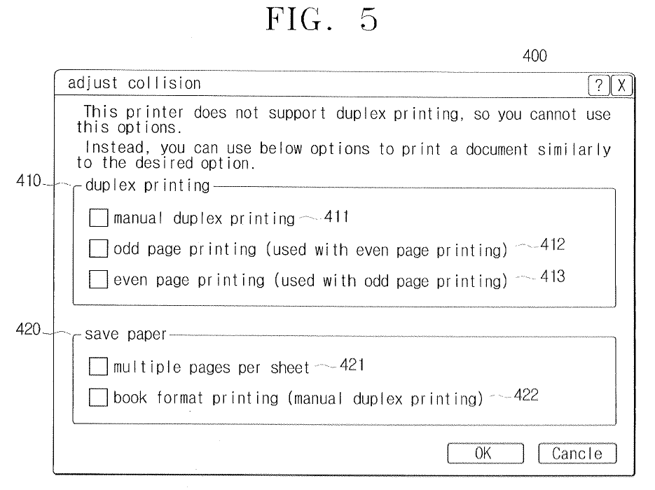

FIG. 3 illustrates a user interface (UI) window to be displayed on a printing control terminal device according to an exemplary embodiment of the present general inventive concept.

Referring to FIG. 3, a user interface (UI) window 300 may include a print option display area 310 on which favorite printing options can be displayed. The print option display area 310 may include a first area to display pre-stored printing options and a second area displaying whether the pre-stored printing options are available or unavailable.

Specifically, a user may set various printing options as favorite printing options, which will be explained with reference to printing options illustrated in FIG. 3. As illustrated in FIG. 3, the printing option “ShortEdge duplex” can cause the printing medium to be printed horizontally. The printing option “3copy_FitToA5” corresponds to a combination of A5 size of printing medium and three copies of the printing medium. The printing option “Top Secret” can cause the words “Top Secret” to be printed on the top of the printing medium irrespective of the corresponding document.

Since the printing option “ShortEdge duplex” may not be available to an image forming apparatus which does not support duplex printing, this option may not be available to all image forming apparatuses connected to the terminal device 100. If a user does not know that a particular image forming apparatus is unavailable, the user may attempt to select the preset printing option. That is, the user may select a frequently used tab to select one of the pre-stored printing options. If a user selects the favorite tab, a list of the pre-stored printing options can be displayed in the print option display area 310. In this case, since a printing option “3copy_FitTo A5” 311 appears to be supported by the currently used image forming apparatus, additional icons may not be displayed next to this option. However, since a printing option “ShortEdge Duplex” 312 is not supported by the currently used image forming apparatus, a symbol “!” 313 may be displayed next to this option, indicating to the user that this option is not supported by the currently selected image forming apparatus. Thus, the user can easily check whether or not the printing option is available.

For example, FIG. 4 illustrates a user interface on which a message 320 is displayed, indicating that pre-stored printing option 312 is not supported by the currently used image forming apparatus. The message 320 may simply indicate that the selected printing option is unavailable, or may include information regarding alternative printing options to the selected printing options.

The above information can appear in a tool tip window 320. The tool tip window 320 may disappear if a predetermined time interval has elapsed, if the mouse cursor moves onto the other area, or if another printing option is selected. The characteristics of the tool tip may be changed, such as the position to be displayed, font type, font size, or background color.

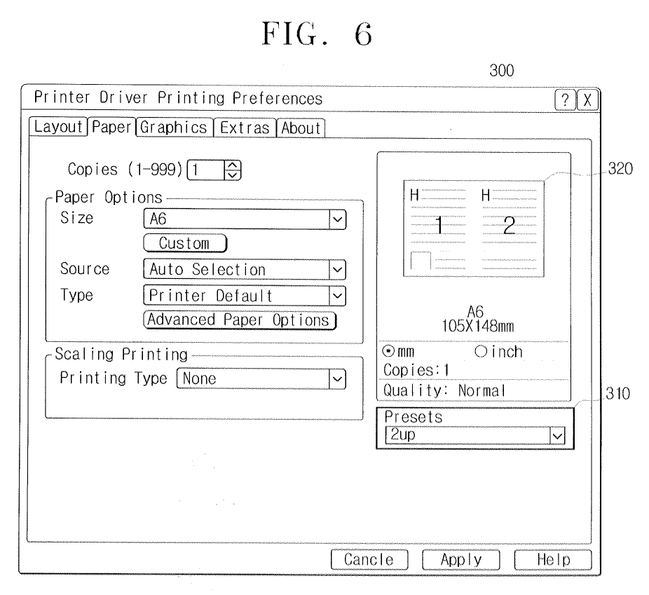

FIG. 5 illustrates a user interface representing that the operation of searching for an alternative printing option can be applied when a e pre-stored printing option is not supported by the currently used image forming apparatus. More specifically, a user interface window 400 can be provided to display alternative printing options which may be used as alternatives to the selected printing option, for example when a user selects the pre-stored duplex printing option on a user interface (UI) window of the image forming apparatus which does not support duplex printing.

Referring to FIG. 5, the UI window 400 can include an area to display a message that the favorite printing option is unavailable on the currently used image forming apparatus, and areas 410 and 420 to display printing options which may be selected as alternatives to the favorite printing options. More specifically, if a user desires to print documents in duplex format, the printer can print odd pages on printing media, and can print even pages on the same printing media using a manual duplex printing check box 411, an odd page printing check box 412, and an even page printing check box 413 which can be displayed on a duplex printing preference area 410 as alternative printing options to the duplex printing option. As a result, the same printed documents as that of duplex printing can be output.

If a user aims to save paper, ‘multiple pages per sheet’ 421 and ‘book format printing’ 422 can be displayed under ‘save paper’ 420 as alternative printing options.

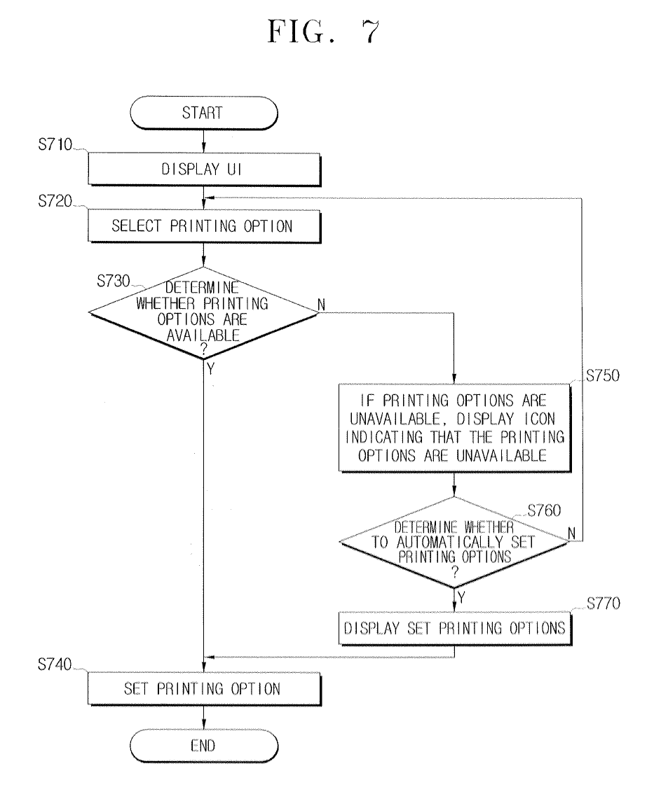

Referring to FIG. 6, when a printing option indicates that multiple pages per sheet is selected, a preview area 320 can be provided to display a particular document before documents are produced in their final form. In this case, since a user may not know how the printing options on the UI may impact the format of a document, the printing results corresponding to the printing options may be displayed on the preview area 320. For example, according to an exemplary embodiment of the present general inventive concept, if a user selects multiple pages per sheet, two pages can be printed on a sheet. However, it may be possible for a user to set the number of pages to be printed on one sheet, and the corresponding number of pages can be printed on a single sheet.

FIG. 7 is a flowchart illustrating a method of controlling a printing operation according to an exemplary embodiment of the present general inventive concept.

Referring to FIG. 7, in operation S710, an image forming apparatus to print a document can be selected from among a plurality of image forming apparatuses, and a user interface (UI) can be displayed to set a printing option corresponding to the selected image forming apparatus and pre-stored printing options.

In operation S730, if a user selects a frequently used printing option tab to apply the pre-stored printing options on the UI, it can be determined whether the pre-stored printing options are available for the currently used image forming apparatus selected on a universal print driver. More specifically, it can be determined whether the pre-stored printing options are supported by the currently used image forming apparatus. For example, if a user selects a favorite printing option tab on the UI in order to apply the pre-stored printing options, it can be determined whether the pre-stored printing options are available for the image forming apparatus selected on the universal print driver in operation S730. More specifically, it can be determined whether the pre-stored printing options may be set for the image forming apparatus selected by a user. For example, if a user selects the combination of duplex printing and A4 size as favorite printing options, these options may not be set for an image forming apparatus which does not support the duplex printing. Accordingly, it may be determined that such a combined printing option is unavailable.

However, if the pre-stored printing options are determined to be available for the selected image forming apparatus, the pre-stored printing options can be set to the selected image forming apparatus, and the operation of setting the printing options can be terminated in operation S770.

If the pre-stored printing options are unavailable, a message stating that the printing options are unavailable can be displayed in operation S750. More specifically, if the pre-stored printing options are unavailable, an icon indicating that the printing options are unavailable may be displayed on an area of the printing option on the UI. If the pre-stored printing options are unavailable, a message indicating that the printing options are unavailable may be displayed as a tool tip. The message may simply indicate that the printing options are unavailable, or may include information regarding printing options which may be selected as alternatives to the pre-stored printing options. The operation of displaying the message on the UI can be similar to that explained above with reference to FIGS. 3 and 4.

If a user selects an unavailable printing option, it can be determined whether to automatically set printing options as alternatives to the pre-stored printing option in operation S760. More specifically, the operation of selecting a printing option to use as an alternative to the pre-stored printing option may be performed by searching for the alternative printing options according to the user's selection or a predetermined algorithm. The determination of whether to automatically apply the printing option may proceed in the same manner as that by which the printing option is selected, or may be automatically selected. A plurality of alternatives to an unavailable printing option may be displayed, and one of the alternative printing options may be selected, or the proper printing option may be set directly, as illustrated in FIG. 5.

If an unavailable printing option is automatically applied, a user may search for alternative printing options, causing the alternative printing options to be displayed in operation S770. The alternative printing options may allow the same printed matter to be output even if additional operations are required. For example, if a user selects one of the alternative printing options, printing conditions to be applied may be displayed in advance. Since the operation of searching for alternative printing options can be the same as that of the searching unit 142, a detailed description thereof will be omitted.

The searched printing options can be set as printing options for the currently selected image forming apparatus in operation S740. When the searched printing options are set, the searched printing options may be stored. More specifically, since the searched printing options can be set as frequently used printing options, the searched printing options may be stored as pre-stored printing options for a plurality of image forming apparatuses, that is, favorite printing options. A favorite printing option selected by a user from among the searched printing options may be stored to respond to storage command by a user, or may be automatically stored. The searched for printing option may be stored as a favorite printing option, or stored as an alternative to an unavailable printing option to the image forming apparatus.

Accordingly, a user can recognize information regarding pre-stored printing options which are unavailable for the currently selected image forming apparatus, and can easily set alternative printing options. The printing control method as illustrated in FIG. 7 may be embodied on the terminal device to control print jobs, and also may be performed on the other terminal device.

As described, according to an exemplary embodiment of the present general inventive concept, information regarding whether pre-stored printing options are available for the currently used image forming apparatus is displayed, so a user can easily recognize whether the printing information is available. An alternative printing option may be easily set without requiring cumbersome manipulation.

The present general inventive concept may be embodied as a program instruction capable of being executed via various computer units and may be recorded in a computer readable recording medium. The computer readable medium may include a program instruction, a data file, and a data structure, separately or cooperatively. The program instructions and the media may be those specially designed and constructed for the purposes of the present general inventive concept, or they may be computer readable media such as magnetic media (e.g., hard disks, floppy disks, and magnetic tapes), optical media (e.g., CD-ROMs or DVDs), magneto-optical media (e.g., optical disks), and/or hardware devices (e.g., ROMs, RAMs, or flash memories, etc.) that are specially configured to store and perform program instructions. Examples of the program instructions may include machine code such as produced by a compiler, and/or files containing high-level language codes that may be executed by the computer with use of an interpreter. The hardware devices above may be configured to act as one or more software modules to implement operations of the general inventive concept, or vice versa.

The present general inventive concept can also be embodied as computer-readable codes on a computer-readable medium, and can be implemented as program code segments to perform operations necessary to the respective elements of the present general inventive concept. The computer-readable medium can include a computer-readable recording medium and a computer-readable transmission medium. The computer-readable recording medium can be any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of controlling a printing job using a universal print driver of a terminal device connectable to a plurality of image forming apparatuses, the method comprising:
selecting one of the plurality of image forming apparatuses;
selecting pre-stored printing options of the plurality of image forming apparatuses;
determining whether the pre-stored printing options are available to the selected image forming apparatus; and
displaying that the pre-stored printing option is unavailable, if at least one of the pre-stored printing options is unavailable.

2. The method of claim 1, wherein the displaying comprises:
displaying an icon indicating that the printing option is unavailable adjacent to the pre-stored printing option, if the pre-stored printing option is unavailable.

3. The method of claim 1, wherein the displaying comprises:
displaying a message as a tool tip indicating that the printing option is unavailable, if the pre-stored printing option is unavailable.

4. The method of claim 1, further comprising:
searching for other printing options as alternatives to the pre-stored printing options.

5. The method of claim 4, further comprising:
asking a user whether to adjust the pre-stored printing options.

6. The method of claim 4, further comprising:
displaying alternative printing options, if alternative printing options to the printing option are returned by the search; and
displaying that there are no alternatives to the printing option, if alternatives to the printing option are not returned by the search.

7. The method of claim 6, further comprising:
selecting at least one of the alternative printing options, and setting the selected printing option of the selected image forming apparatus, if alternative printing options to the printing option are returned by the search.

8. The method of claim 7, wherein the setting comprises:
displaying printing conditions to be applied in advance, if a user selects at least one of the alternative printing options.

9. The method of claim 7, further comprising:
storing the set printing option.

10. The method of claim 9, wherein the storing comprises:
storing the set printing option as an alternative to the selected pre-stored printing options.

11. A terminal device to control a print job using a universal print driver connectable to a plurality of image forming apparatuses, the device comprising:
a user interface (UI) to set a printing option of a selected image forming apparatus;
a storage unit to store pre-stored printing options of the plurality of image forming apparatuses;
a determination unit to determine whether the pre-stored printing options are available to the selected image forming apparatus; and
a control unit to control the UI to display that the pre-stored printing options are unavailable if it is determined that the pre-stored printing options are unavailable.

12. The device of claim 11, wherein the UI generates a user interface (UI) window comprising a first area on which pre-stored printing options are displayed and a second area on which the availability of pre-stored printing options is displayed.

13. The device of claim 12, wherein if the pre-stored printing options are unavailable, the UI displays an icon on the second area of the UI window indicating that the pre-stored printing options are unavailable.

14. The device of claim 11, wherein the UI displays a message as a tool tip indicating that the printing options are unavailable.

15. The device of claim 11, further comprising:
a searching unit to search for other printing options as alternatives to the pre-stored printing options.

16. The device of claim 15, wherein the UI asks a user whether to adjust the pre-stored printing options.

17. The device of claim 15, wherein if alternative printing options are returned by the search, the UI displays the alternative printing options, and if alternative printing options are not returned by the search, the UI displays that there are no available alternative printing options.

18. The device of claim 17, wherein if a user selects at least one of the alternative printing options, the UI displays printing conditions to be applied.

19. The device of claim 17, wherein if alternative printing options are returned by the search, the control unit sets at least one of the alternative printing options input through the UI of the image forming apparatus.

20. The device of claim 19, wherein the control unit stores the set printing options in the storage unit as pre-stored printing options of the plurality of image forming apparatuses.

21. A terminal device to control a print operation using a universal print driver connectable to a plurality of image forming apparatuses, the terminal device comprising:
a user interface (UI) to set a printing option of a selected image forming apparatus;
a print driver to determine whether the set printing option is available to the selected image forming apparatus;
a control unit to control the UI to display a result of the determining; and
a storage device to store printing options of the plurality of image forming apparatuses,
wherein when the print driver determines that the set printing option is not available to the selected image forming apparatus, the print driver searches the storage device to determine whether alternative printing options are available to the selected image forming apparatus.

22. A method of setting a printing option using a universal print driver of a terminal device connectable to a plurality of image forming apparatuses, the method comprising:
setting a printing option of a selected image forming apparatus;
determining whether the set printing option is available to the selected image forming apparatus;
displaying a result of the determining; and
selecting an alternative image forming apparatus when it is determined that the set printing option is not available to the selected image forming apparatus.

23. The method of claim 22, further comprising:
storing predetermined printing options of the plurality of image forming apparatuses;
searching the predetermined printing options to determine whether alternative printing options are available to the selected image forming apparatus when it is determined that the set printing option is not available to the selected image forming apparatus; and
storing at least one alternative printing option as a favorite printing option of the selected image forming apparatus when it is determined that alternative printing options are available to the selected image forming apparatus.
